(19) United States
(12) Patent Application Publication
(10) Pub. No.: US 2023/0228722 A1
(43) Pub. Date: Jul. 20, 2023

(54) APPARATUS AND METHOD FOR MEASUREMENT OF HALOGENS IN SAMPLES

(71) Applicant: UNIVERSITY OF WASHINGTON, Seattle, WA (US)

(72) Inventor: Brian Pinkard, Seattle, WA (US)

(73) Assignee: UNIVERSITY OF WASHINGTON, Seattle, WA (US)

(21) Appl. No.: 17/998,459

(22) PCT Filed: Apr. 26, 2021
(86) PCT No.: PCT/US2021/029173

§ 371 Date: Nov. 10, 2022

Related U.S. Application Data
(60) Provisional application No. 63/023,866, filed on May 12, 2020.

(51) Int. Cl. G01N 30/88; G01N 30/30; G01N 30/06; G01N 30/32

(52) U.S. Cl. CPC G01N 30/88; G01N 30/30; G01N 30/06; G01N 30/32; G01N 2030/8845; G01N 2030/067

(57) ABSTRACT

Apparatus and methods for determining a concentration of one or more halogen-containing ions in a sample, including but not limited to: soils, aquifers, groundwater, drinking water, soil, tissue, blood, sewage sludge, compost, and landfill leachate, Particularly, the apparatus and processes are used for the destruction of per- and polyfluoroalkyl substances (PFAS), per- and polyfluorocarbons (PFCs), pesticides, munitions, 1,4-dioxane, pharmaceuticals, microplastics, and others. High destruction efficiencies of these substances is desirable for determination of compliance with government regulations. Apparatus include batch- and continuous-type reactor systems. Processes include supercritical water oxidation (SCWO) and hydrothermal alkaline treatments (HALT).

### CROSS-REFERENCE(S) TO RELATED APPLICATION(S)

This application claims the benefit of U.S. Provisional Application No. 63/023,866, filed on May 12, 2020, incorporated herein in its entirety by reference.

### BACKGROUND

Supercritical water oxidation (SCWO) is a process where oxidative reaction mechanisms are used to mineralize a target reagent within the supercritical phase of water, which is defined as temperatures and pressures exceeding 374° C. and 22.1 MPa, respectively. The oxidative reaction mechanisms are primarily driven by OH and HO₂ radicals, generated through the addition of O₂, air, H₂O₂, or another radical source. The SCWO process has been shown to rapidly oxidize and mineralize various reagents, such as biomass, sewage sludge, chemical warfare agent hydrolysate, pesticides, various industrial effluents, and other recalcitrant molecules. Notably, SCWO can be used to completely mineralize environmental contaminants, such as per- and polyfluoroalkyl substances (PFAS), per- and polyfluorocarbons (PFCs), pesticides, munitions, 1,4-dioxane, pharmaceuticals, microplastics, and others.

Analytical methods for detecting PFAS or PFCs in the environment are of particular interest, as contamination of groundwater and drinking water with PFAS is an emerging and urgent water security crisis. PFAS have been extensively used since the 1940s due to their chemical stability and distinct thermophysical properties. Widespread use of PFAS in manufacturing processes, consumer goods, and firefighting foams has directly contributed to contamination of soils and municipal drinking water supplies at concentrations significantly exceeding recommended exposure levels. Use of aqueous film-forming foams (AFFF) for firefighting training has particularly contributed to the water contamination problem. PFAS show high toxicity, even in the low part-per-trillion range, and the stability of the C—F bond means that PFAS are perpetually stable in the environment. Notable sites of PFAS contamination include military bases, airports, and locations near chemical manufacturing plants. Due to the stability of the PFAS molecule, and lack of destructive treatment options, PFAS are often found in high concentrations within such matrices as municipal sewage sludge, compost, livestock, and common food items.

Effective remediation of PFAS commonly involves “pump-and-treat” of contaminated water supplies or soil washing. Contaminated water passes through an industrial filtration system (e.g. reverse osmosis), producing clean water and a PFAS-rich brine. End-of-life destruction of the hyper-concentrated PFAS brine requires energy-intensive processing, as does pumping and filtration.

Current remediation methods for PFAS-impacted sites primarily include (a) filtration of PFAS from drinking water or (b) in situ fixation of PFAS in contaminated soils. The most commonly used filtration technologies include reverse osmosis (RO), or PFAS adsorption with granulated activated carbon (GAC) or ion exchange resins (IXR). All filtration and fixation technologies serve to capture PFAS molecules, but do not destroy PFAS molecules. End-of-life disposal with complete defluorination (cleaving the C—F bonds) is needed to eliminate the risk of subsequent environmental re-contamination, or future liability.

Due to widespread PFAS contamination of soils and aquifers, coupled with emerging regulations, there is a growing need for analysis methods to quantify target PFAS molecules and overall PFAS in a variety of matrices, including but not limited to: groundwater, drinking water, soil, tissue, blood, sewage sludge, compost, and landfill leachate. The typical analysis method for quantifying PFAS molecule concentrations (such as PFOS or PFOA) is liquid-chromatography, mass spectrometry (LC-MS/MS). Analytical standards and methods exist for PFAS analysis via LC-MS/MS, however, only ˜50 of the >5000 known PFAS have acceptable analytical standards and methods. Methods for attempting to quantify the total quantity of PFAS in a sample include adsorbable organofluorine (AOF) and extractable organofluorine (EOF) where a sorbent (such as ion resin) or solvent are used to isolate fluorocarbons for subsequent LC-MS/MS analysis. The total oxidizable precursor (TOP) assay is a method for indirectly estimating total PFAS content, through partially oxidizing PFAS molecules to key intermediate products, which can subsequently be analyzed by LC-MS/MS. Several recent studies have indicated that LC-MS/MS is inadequate to measure all organofluorine contaminants at sites with AFFF contamination.

The current method for quantifying total organofluorine (TOF) is combustion ion chromatography (CIC) where wet air oxidation (typically at temperatures between 900 and 1000° C.) is followed by ion chromatography. The oxidation step serves to convert organofluorine to gaseous HF, which is subsequently adsorbed and/or collected and introduced to a liquid matrix for analysis via ion chromatograph.

There is, however, significant skepticism that combustion ion chromatography can accurately measure total organic fluorine from PFAS-laden samples, with the current efforts pointing to TOF CIC not working well to measure fluorine from PFAS. Therefore, there remains a need for a method and device that can accurately and reliably measure TOF, especially with PFAS.

### SUMMARY

The present invention is an apparatus and method for determining the total concentration or content of halogens in a liquid or solid sample, by using supercritical water oxidation (SCWO) or hydrothermal alkaline treatment (HALT). In one embodiment, the reaction conditions for SCWO are supercritical phase water conditions. In one embodiment, the reaction conditions for hydrothermal alkaline treatment for HALT are sub-critical phase water conditions. The herein described methods and apparatus can also be used to quantify the total content of any halogens, metals, or other elements which are not converted to gaseous products during the SCWO process.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows steps for analyzing total organofluorine or other anions/cations using supercritical water oxidation, ion chromatography (SWIC);

FIG. 2 shows an example schematic illustration of a SWIC apparatus coupled to an ion chromatograph;

FIG. 3 shows an example schematic illustration of a batch reactor;

FIG. 4 is a graph showing the PFOS conversion efficiencies (95% confidence interval) during the destruction of PFOS in s SCWO batch reactor;

FIG. 5 is a graph showing the PFHpS conversion efficiencies (95% confidence interval) during the destruction of PFOS in a SCWO batch reactor;

FIG. 6 is a graph showing the defluorination efficiencies (95% confidence interval) during the destruction of PFOS in a SCWO batch reactor;

FIG. 7 is a graph showing the total fluorine mass balance from reagent to products during the destruction of PFOS in a SCWO batch reactor;

FIG. 8 is a SCWO reaction mechanism for PFOS destruction;

FIG. 9 shows an example schematic illustration of a continuous reactor; and

FIG. 10 is a graph showing PFAS reduction from a landfill leachate matrix in a batch and continuous reactor at various residence times.

### DETAILED DESCRIPTION

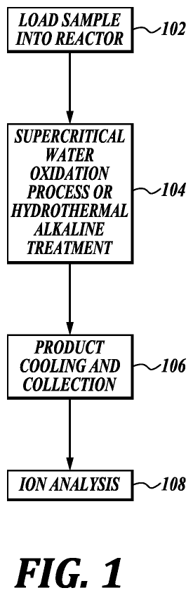

Referring to FIG. 1, the herein described analytical methods involves the following sequential steps. In block 102, the method includes loading of the liquid or solid sample to the reactor vessel either manually or via a suitable pump or compressor. The mass of each reactant is fixed and measured into the reactor vessel in accordance with the determined mass. In block 102, in one embodiment, the method includes adding aqueous hydrogen peroxide as an oxidant. From block 102, the method enters block 104.

In block 104, the method includes mineralization of the sample at high temperatures and pressures, such as supercritical water conditions. In one embodiment, supercritical water conditions may include a pressure greater than or equal to 22.1 MPa and a temperature of greater than or equal to 374° C. From block 104, the method enters block 106.

In block 106, the method includes cooling and expansion of the reaction products to ambient or near-ambient temperatures and pressures. In one embodiment, the produced ion are collected in an aqueous liquid product. The method includes collection of the liquid and solid reaction products in any suitable collection vessel. From block 106, the method enters block 108.

In block 108, the method includes the introduction of the collected reaction products to a suitable analytical instrument for analysis and quantification of the halogen of interest. In one embodiment, the products may be introduced to the analytical instrument through directly coupling the analytical instrument to the collection vessel or to the reactor vessel, for example, to inject the aqueous product directly to an ion chromatograph. In one embodiment, the method may include pH buffering of the sample to a pH amenable for introducing to the analytical instrument.

The methods of FIG. 1 can be used for destruction of per- and polyfluoroalkyl substances (PFAS), per- and polyfluorocarbons (PFCs), pesticides, munitions, 1,4-dioxane, pharmaceuticals, microplastics, and others using SCWO or HALT processes in both a batch and continuous reactors.

In one embodiment of the method of FIG. 1, a first method is used for determining a concentration of one or more halogen-containing ions in a sample, wherein the method comprises contacting the sample with an oxidant in a volume of water under supercritical conditions to form a product in a reactor; in a collection zone, reducing the temperature of the product; and providing the cooled product to an analyzer to determine the concentration of the one or more halogen-containing ions in the sample. In one embodiment, the first method can be performed in a batch reactor or in a continuous reactor.

In one embodiment of the first method, the method includes contacting the sample in the reactor at a temperature in a range of 500° C. to 750° C. In one embodiment of the first method, the method includes contacting the sample in the reactor at a temperature in a range of 500° C. to 650° C.

In one embodiment of the first method, the method includes contacting the sample in the reactor at a pressure sufficient to maintain a supercritical phase of water.

In one embodiment of the first method, the temperature and/or pressure are sufficient to fully liberate the halogen atoms from the sample.

In one embodiment of the first method, the sample is a solid sample (e.g. sewage, soil, compost, tissue).

In one embodiment of the first method, the sample is a liquid sample (e.g. landfill leachate, groundwater, drinking water, blood).

In one embodiment of the first method, the analyzer is an ion chromatograph or an ion selective electrode.

In one embodiment of the first method, the concentration of F⁻ ions is determined. In one embodiment of the first method, the analyzer is coupled to the collection zone to receive the cooled product.

In one embodiment of the method of FIG. 1, a second method for determining a concentration of fluoride ions in a sample, comprises contacting the sample with an alkaline amendment in a volume of water under sub-critical liquid water conditions to form a product in a reactor; cooling the product; and providing the cooled product to an analyzer to determine the concentration of the fluoride ions in the sample. In one embodiment, a hydrothermal alkaline treatment or HALT process as used herein can include a reaction including a reagent, water, and an alkaline amendment under sub-critical water conditions.

In one embodiment of the second method, the method includes contacting the sample in the reactor at a temperature less 374° C. and at a pressure sufficiently high to maintain a liquid phase of water.

In one embodiment of the second method, the alkaline amendment is selected from NaOH, KOH, LiOH, NH₄OH, or a combination.

In one embodiment of the second method, the sample is a solid sample (e.g. sewage, soil, compost, tissue).

In one embodiment of the second method, the sample is a liquid sample (e.g. landfill leachate, groundwater, drinking water, blood).

In one embodiment of the second method, the analyzer is an ion chromatograph or an ion selective electrode.

In one embodiment of the second method, the analyzer is coupled to the reactor with a conduit and the method comprises transferring the product from the reactor to the analyzer after the cooling step.

In one embodiment of the second method, the method further comprises allowing the product to cool in the reactor, taking the cooled product out of the reactor, and analyzing the product.

In one embodiment of the second method, the sample includes per- and/or polyfluoroalkyl substances (PFAS).

In one embodiment of the second method, the method includes contacting the sample in the reactor at a temperature in a range of 250° C. to 374° C.

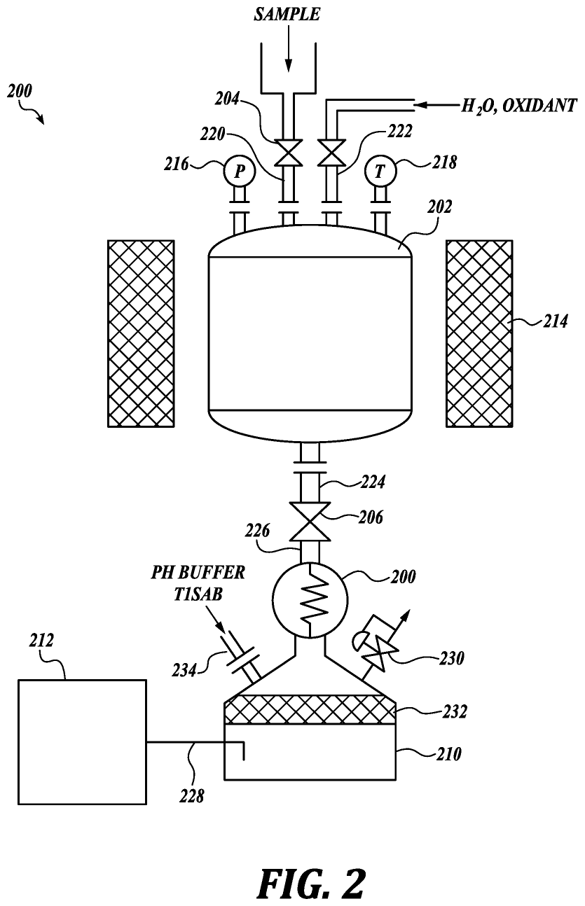

Referring to FIG. 2, one embodiment of an apparatus 200 is schematically illustrated. The apparatus 200 includes a high-temperature pressure vessel 202 which facilitates a hydrothermal alkaline treatment (HALT) or supercritical water oxidation (SCWO) process to mineralize a solid or liquid sample to halogen ions suitable for analysis with standard measurement apparatuses. For example, an ion chromatograph (IC) is used to analyze the resulting ion content in the preferred configuration, although other apparatuses may be used, including but not limited to, ion selective electrode (ISE).

In one embodiment, the reactor vessel 202 is constructed from a nickel-base alloy for corrosion resistance (e.g., Inconel 625, Hastelloy C-276), although other materials are also possible, including but not limited to: Inconel 600 and stainless steel 316.

In one embodiment as shown in FIG. 2, the reactor vessel 202 may include a valve 204 for introducing the reactants. After reaction, the products may be removed from the reactor vessel 202 via a second valve 206. In one embodiment, after cooling the reactor vessel 202 to subcritical temperatures (<374° C.) the valve 206 is opened and the compressed liquid product expands/cools through a cooling coil 208, for example, which may actively or passively cool the product. The product the reaches a collection vessel 210 which can be directly coupled to an ion chromatograph 212. However, other configurations may also be possible, including, but not limited to: fully cooling the reactor vessel 202 to ambient conditions prior to sampling, and cooling and condensing the liquid product inside of the collection vessel 210.

In one embodiment, an inductive heater, electric furnace, heated sand bath, or electric resistive heater 214 is used to generate supercritical phase water temperatures (>374° C.) and temperatures necessary for analysis (>300° C.) within the reactor vessel 202, although other heating methods may be used. In one embodiment, the heater 214 is used for generating sub-critical phase water temperatures (<374° C.)

In one embodiment, a pressure gauge or pressure transducer 216 monitors the internal pressure in the reactor vessel 202, and a thermocouple 218 measures the internal temperature in the reactor vessel, although both pressure and temperature sensors are optional. The signals from the pressure and temperature sensors may be used to control the heater 214 using a controller.

In one embodiment, the apparatus may include a pressure relief valve or rupture disc, and additional thermocouples to monitor temperature in locations such as the collection vessel, although both are optional.

In one embodiment, the apparatus 200 may be used as a “batch” reactor for both the SCWO and HALT processes. In one embodiment, the apparatus 200 may be used as a “continuous” reactor for both the SCWO and HALT processes.

In one embodiment of the disclosed methods, a solid sample (e.g. sewage, soil, compost, tissue) of known mass is loaded into a fixed volume of deionized (DI) water and H₂O₂ in a supercritical water oxidation reactor and completely mineralized, after which the liquid product is introduced to an ion chromatograph for analysis. As used herein, “mineralized” means fully decomposed and/or oxidized to the simplest molecular state.

In another embodiment of the disclosed methods, a liquid sample (e.g. landfill leachate, groundwater, drinking water, blood) of known mass is loaded into a fixed volume of deionized (DI) water and H₂O₂ in a supercritical water oxidation reactor and completely mineralized, after which the liquid product is introduced to an ion chromatograph for analysis.

In another embodiment of the disclosed methods, a liquid or solid sample of known mass is loaded into a fixed volume of deionized (DI) water with NaOH amendment (optimally >5 M-NaOH) and reacted sufficiently to cleave halogens from parent compounds, after which the product is introduced to an IC for analysis.

In varying embodiments of the disclosed methods, the liquid product can be analyzed for halogens, including, but not limited to: fluoride, chloride, bromide, iodide, and astatide via analysis methods including, but not limited to: ion chromatography, ion selective electrode.

In varying embodiments of the disclosed methods, pressures sufficient to keep the sample in the liquid (subcritical) or supercritical state (>22.1 MPa) are generated autogenically through expansion of the water at high temperatures, although a head of gas which is pressurized to an initial set pressure, or a high pressure pump or compressor may also be used to generate supercritical pressures.

In embodiments of SCWO processes, the oxidant source can include aqueous H₂O₂, although other oxidants may also be used, including but not limited to: compressed O₂, compressed air. Known quantities of the sample and H₂O₂ are loaded manually through a hand valve, for example, but may also be introduced to the reactor vessel by a pump or multiple pumps.

In one embodiment, referring to FIG. 2, the first apparatus 200 for determining a concentration of one or more halogen-containing ions in a sample, comprises a reactor 202 having a first inlet 220 connected to the sample supply and an outlet 224, the reactor 202 configured for contacting the sample in a volume of water under supercritical conditions to form a product; a collection zone 210 having an inlet 226 connected to the outlet 224 of the reaction zone, and an outlet 228, the collection zone configured for reducing the temperature of the product; and an analyzer 212 having an inlet connected to the outlet of the collection zone, the analyzer configured to determine the concentration of the one or more halogen-containing ions in the sample.

In one embodiment of the first apparatus, the sample is contacted with an oxidant.

In one embodiment of the first apparatus, the reactor comprises one or more of second inlets 222.

In one embodiment of the first apparatus, the one or more of second inlets are connected to an oxidant supply, a water supply, or both.

In one embodiment of the first apparatus, the collection zone further comprises a cooling zone 208 configured to reduce the temperature of the product.

In one embodiment of the first apparatus, the cooling zone 208 comprises a heat exchanger in substantial thermal contact with the collection zone (e.g., a cooling coil).

In one embodiment of the first apparatus, the collection zone further comprises a pressure regulator 230 configured to reduce the pressure in the collection zone.

In one embodiment of the first apparatus, the pressure is reduced through a capillary tube.

In one embodiment of the first apparatus, the pressure regulator comprises an expansion valve.

In one embodiment of the first apparatus, the collection zone further comprises a filter 232 (e.g., a size exclusion filter configured to remove solids from the product).

In one embodiment of the first apparatus, the collection zone further comprises a second inlet 234, for introducing a solution serving as a pH buffer or a total ionic strength adjustment buffer (TISAB).

In one embodiment of the first apparatus, the analyzer comprises a detector for halogen ions including one or more of F⁻, Cl⁻, Br⁻, I⁻, or At⁻.

In one embodiment of the first apparatus, the analyzer comprises an ion chromatograph (IC) or an ion selective electrode (ISE).

In one embodiment of the first apparatus, the concentration of F⁻ ions is used to determine the total quantity of elemental fluorine in the sample.

In one embodiment of the first apparatus, the reactor is maintained at a temperature in a range of 500° C. to 750° C.

In one embodiment of the first apparatus, the reactor is maintained at a pressure sufficient to maintain a supercritical phase of water

In one embodiment of the first apparatus, the sample is a solid sample (e.g. sewage, soil, compost, tissue).

In one embodiment of the first apparatus, the sample is a liquid sample (e.g. landfill leachate, groundwater, drinking water, blood).

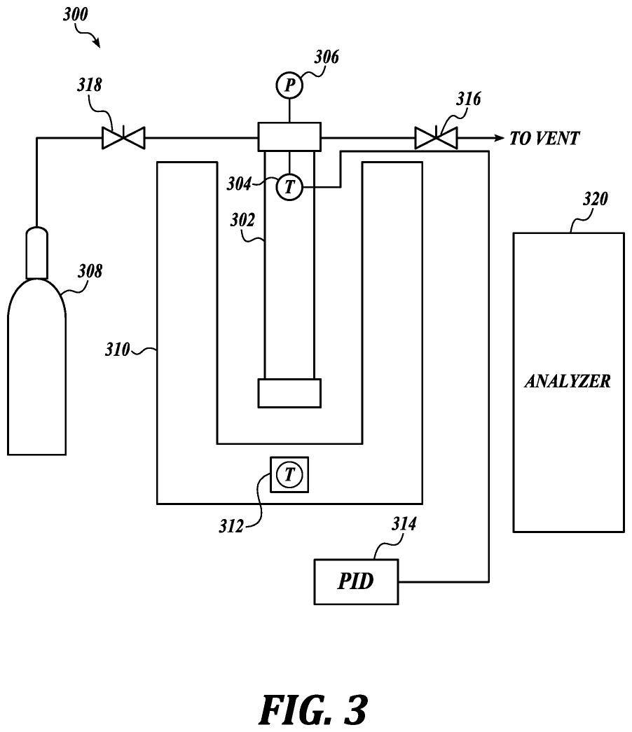

In one embodiment, referring to FIG. 3, a second apparatus 300 for determining a concentration of fluoride ions in a sample, comprises a reactor 302 configured to open and close to allow filling the reactor with reactants and removing products after reaction of the reactants, and the reactor is configured to withstand an internal pressure of at least 22.1 MPa and an internal temperature of at least 374° C., wherein the reactor is filled with reactants including water, one or more per- and polyfluoroalkyl substances, and an alkaline amendment; a heater 310 configured to heat the reactor with the reactants to raise the internal temperature and internal pressure of the reactor; and a fluoride ion selective electrode or ion chromatography analyzer 320 to determine the concentration of fluorine ions of a sample removed from the reactor after reaction. In one embodiment, the apparatus 300 can be referred to as a “batch” reactor, and used for SCWO and HALT processes.

In one embodiment of the second apparatus, the alkaline amendment is selected from NaOH, KOH, LiOH, NH₄OH, or a combination.

In one embodiment of the second apparatus, the reactor further comprises a controller to maintain an internal reactor temperature in a range of 250° C. to 374° C.

In one embodiment of the second apparatus, a fluoride ion selective electrode or ion chromatography analyzer is coupled to the reactor to receive a cooled product after reaction of the reactants.

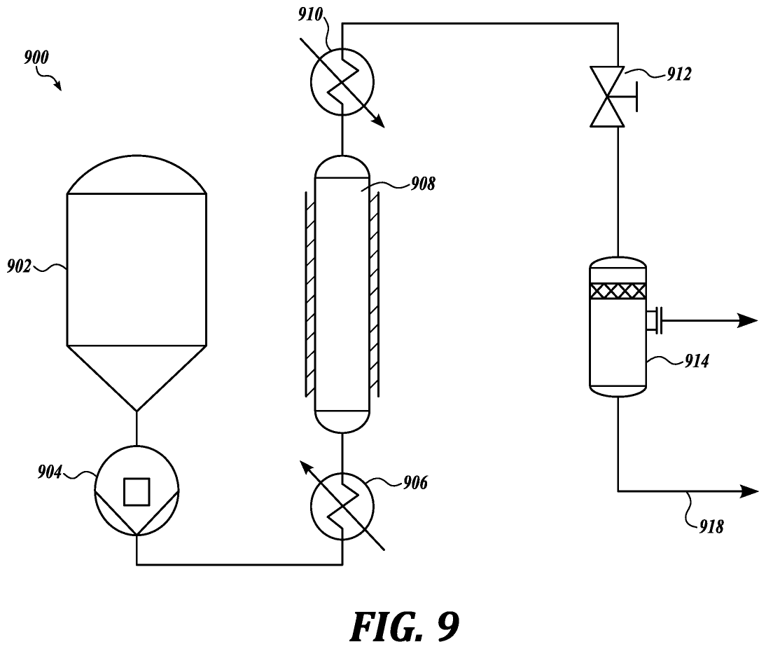

FIG. 9 is a schematic illustration of a third apparatus 900 for use in continuous SCWO and HALT processes. The apparatus 900 includes a reactor vessel 908. In one embodiment, a feed tank 902 contains the reagents, and an outlet of the feed tank 902 is connected to a positive displacement pump 904 which pumps the reagent or reagents into a bottom inlet of the reactor 908 after heating via a heater 906. Additional feed tanks can be connected to the reactor 908 in a similar manner for containing other reagents. In one embodiment, the heater 906 is a radiant heater. The heater 906 can be controlled by one or more thermocouples in contact with the flow at one or more locations along the reactor 908. The thermocouples can provide the internal temperature of the reactor 908. In one embodiment, a heat exchanger 910 can be placed at the outlet of the reactor 908 for quenching of the reaction products. In one embodiment, a back pressure regulator 912 is provided on the outlet of the reactor 908. After quenching, the products are directed into a vessel, such as a vapor-liquid separator 914. The vapor products 916 are collected from the tops of the separator 914, while the liquid products 918 are collected from the bottom of the separator.

In one embodiment, the apparatus 900 can be referred to as a “continuous” reactor, and used for SCWO and HALT processes.

### Example 1: Destruction of PFOS in a SCWO Batch Reactor

Reagents

Reagents are prepared with aqueous perfluorooctanesulfonic acid (˜40 wt %, Sigma Aldrich), deionized (DI) water (ρ=18.2 MΩ-cm) and aqueous H₂O₂ (30 wt %, Fisher Scientific). NaF (>99%, Sigma Aldrich) is used to test fluoride recovery from the batch system. The reagent consists of perfluorooctanesulfonic acid (PFOS) and H₂O₂ premixed with DI water to target concentrations of ˜30 mg-PFOS/L and 68 g-H₂O₂/L. Two 5 mL samples of the unreacted reagent are analyzed via LC-QToF-MS to precisely quantify the initial PFOS concentration at 28.63 mg-PFOS/L. Small concentrations of perfluoroheptanesulfonic acid (PFHpS) and perfluorohexanesulfonic acid (PFHxS) are measured in each untreated sample, at respective initial concentrations of ˜0.31 mg-PFHpS/L and ˜0.014 mg-PFHxS/L, likely due to impurities in the PFOS used to prepare reagents.

Experimental Apparatus and Procedures

A 50 mL stainless steel 316 (SS316) batch reactor is used for all experiments, designed to operate at temperatures up to 500° C. and pressures up to 35 MPa. SS316 construction and external heating limits the maximum internal operating temperature to 500° C., although continuous SCWO reactors can be operated at temperatures up to 650° C. by leveraging internal heating and Inconel 625 construction. A schematic of the batch reactor apparatus 300 is shown in FIG. 3. The reactor 302 is equipped with an internal 3.175 mm diameter Type-K thermocouple 304 and a pressure gauge 306 for ensuring isothermal and isobaric reaction conditions. Pressurized N₂ in a tank 308 is used to purge air from the system, and to provide a gas cap at an initial pressure required to achieve the desired experimental pressure of 25 MPa after heating to supercritical conditions. Isothermal reaction conditions are achieved by inserting the sealed reactor vessel into an Applied Test Systems (Butler, Pa.) Series 3110 furnace 310. During each experiment, the reactor 302 is placed into the furnace 310 and brought to the desired internal temperature, defined as the “zero time”. After reaching the desired residence time the reactor 302 is removed from the furnace 310 and cooled to room temperature. The gaseous products are vented, the reactor is opened, and liquid products are collected in HDPE sample containers. The system is rinsed several times with DI water between experiments.

To test fluoride recovery from the reactor, a NaF solution measured to contain 38.74 mg/L of F⁻ was loaded into the reactor and brought to 500° C. The recovered liquid samples were measured to contain 42.02 mg/L of F⁻, on average. The slight increase in concentration is likely due to a minor loss of steam out of the reactor vent after quenching. Correcting for steam losses (a slight distillation effect) results in a “distillation-corrected” recovered fluoride concentration of 38.54 mg/L indicating good fluoride recovery within the system (no significant adhesion of fluoride to the reactor walls). Measured fluoride, PFOS, and PFHpS values are all corrected for this distillation effect.

Experimental Conditions

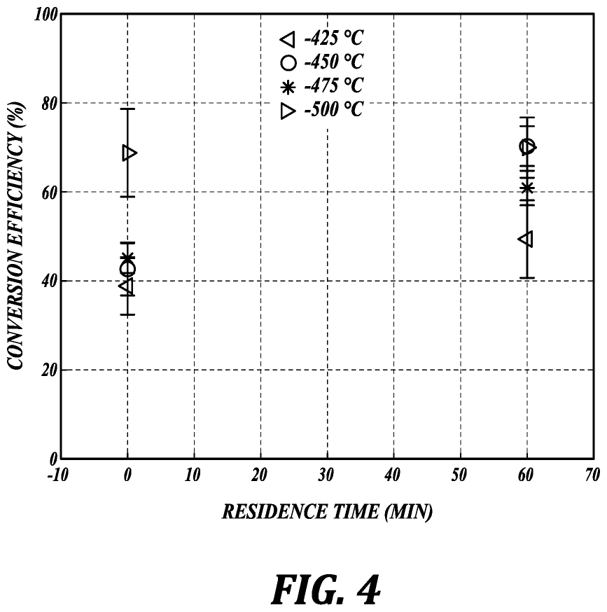

Temperatures are varied from 425 to 500° C., and residence times varied from 0 to 60 min, with experimental pressure maintained above the critical pressure of 22.1 MPa through autogenic expansion of the water. 10 mL of reagent are treated in each batch. All conditions are tested in duplicate. Preliminary blank tests show that the internal reactor temperature increases from 300° C. to 400° C. within 18.6 min, equivalent to a reactor heating rate of 5.4° C./min. During cooling the internal temperature drops from 400° C. to 300° C. within 1.6 min, equivalent to a reactor cooling rate of 62.5° C./min. FIGS. 4 to 7 show the full range of experimental conditions.

Product Analysis

Liquid samples from each experimental condition are analyzed via fluoride ion-selective electrode (ISE) for the resulting concentration of F⁺ ions. The fluoride ISE used is a Thermo Scientific Orion Star A214 pH/ISE/mV/Temperature Benchtop Meter Kit with a stainless steel automatic temperature compensation (ATC) probe, a mechanical stirrer probe, and a fluoride electrode. Calibration was performed using TISAB II standards at 0.1 ppm, 0.5 ppm, 1 ppm, 2 ppm, and 10 ppm. The slope of the calibration curve was calculated at −55.15 mV at the measured temperature of 16.0° C., within the expected instrument range of −54 mV to −60 mV.

Liquid products are also analyzed with targeted high-resolution LC-QToF-MS to screen, identify, and quantify the presence and concentration of 45 potential PFAS compounds in the liquid product. The 45 PFAS are automatically targeted via a custom algorithm, which includes C₄ to C₁₈ perfluoroalkanoic acids, C₃ to C₁₂ perfluoroalkane sulfonates, C₆ to C₁₂ fluorotelomer sulfonates, and C₆ to C₁₂ fluorotelomer alkanoic acids. LC-QToF-MS allows for quantifying remaining PFOS, as well as the production of intermediate liquid PFAS.

All samples analyzed via high resolution LC-QToF-MS are transferred to 15 mL pre-weighed polypropylene centrifuge tubes (Falcon; Corning, N.Y.) tubes. The following reagents are added to each aliquot: 63.8% water sample, 3.3% Fisher Scientific Optima LC-MS grade water (Hampton, N.H.) mixed with 0.1% of Optima LC-MS grade ammonium hydroxide, 13.6% Optima LC-MS grade methanol, 9.6% of Optima LC-MS grade isopropanol surrogate mixture, and 9.6% of Optima LC-MS grade methanol surrogate mixture. Surrogate concentrations are spiked at 74 pg/mL and 1.35 mL of sample was transferred into a 1.5 mL autosampler vial.

One mL of sample was injected in a SCIEX X500R QTOF System (Framingham, Mass.). The analytical column used was Phenomenex Gemini C18, 3 mm×100 mm×5 μm (Torrance, Calif.). Prior to the column, a Phenomenex C18 SecurityGuard™ 4 mm×2 mm (Torrance, Calif.) and two Agilent Zorbax 4.6 mm×12.5 mm×6 μm DIOL guard columns (Santa Clara, Calif.) are used. A Phenomenex Luna 5 μm C18(2) 100 Å LC column 30×3 mm (Torrance, Calif.) is used as a delay column to aid in chromatographic separation. The column oven temperature is set to 40° C. The eluent mobile phases used are (a) Optima LCMS grade water with 20 mM Fisher Scientific HPLC grade ammonium acetate (Hampton, N.H.) and (b) 100% Optima LC-MS grade methanol. The autosampler rinse solution was 100% Optima LC-MS grade isopropanol. Eluent flow rate is held at 0.60 mL/min, and composition is ramped from 90% (a) to 50% (a) over the first 0.5 min, then to 1.0% (a) at 8 min and held until 13 min, then ramped to 90% (a) at 13.5 min and held constant until 20 min.

Electrospray ionization in negative mode (ESI−) with SWATH® Data-Independent Acquisition for both TOF-MS and MS/MS mode are used. Precursor ion data is collected for mass-to-charge ratios (m/z) of 100 to 1200 for 1283 cycles with a total scan time of 842 ms and accumulation time of 20 ms, with ion spray voltage set at −4500 V and temperature set to 550° C. The ion source, curtain, and collision gas for collisionally activated dissociation (CAD) are set to 60 psi, 35 psi, and 10 psi, respectively. For QTOF scanning, the collision energy is set to −5 V and the declustering potential to −20 V, both with no spread. Product ion (MS/MS) scanning is conducted for m/z 50 to 1200 Da. The accumulation time for each SWATH window is 50 ms and collision energy was −35 V with 30 V spread. The instrument is mass calibrated every 5 injections using SCIEX ESI Negative Calibration Solution.

Results & Discussion

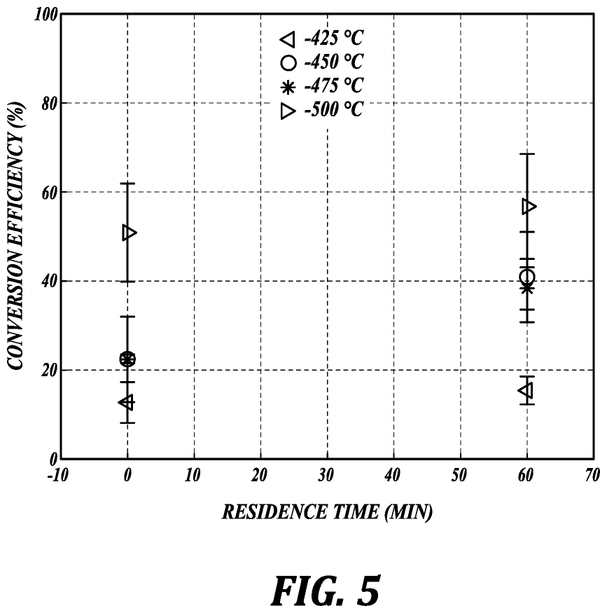

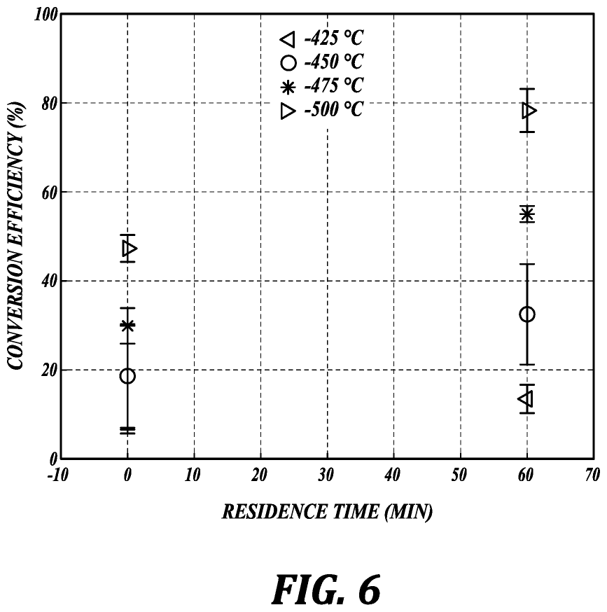

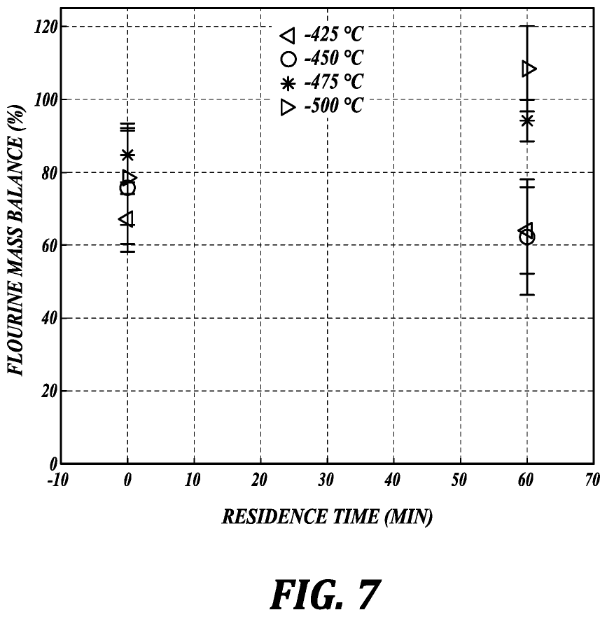

FIGS. 4 to 7 present PFOS, and PFHpS yields, defluorination efficiencies, and fluorine mass balances from all experiments. FIG. 4 is a graph showing the PFOS conversion efficiencies (95% confidence interval) during the destruction of PFOS in s SCWO batch reactor. FIG. 5 is a graph showing the PFHpS conversion efficiencies (95% confidence interval) during the destruction of PFOS in a SCWO batch reactor. FIG. 6 is a graph showing the defluorination efficiencies (95% confidence interval) during the destruction of PFOS in a SCWO reactor. FIG. 7 is a graph showing the total fluorine mass balance from reagent to products during the destruction of PFOS in a SCWo batch reactor.

Results show high fluorine conversion for experiments conducted at 500° C., with a maximum fluorine conversion of 78.2% achieved after 60 min of reaction (FIG. 6). A corresponding PFOS conversion of 70.0% is observed at the same condition (FIG. 4). The percent fluoride conversion being higher than the PFOS conversion for this reaction condition is counterintuitive. This observation may be attributed to errors arising from the adsorption of unreacted PFOS to the reactor walls between experiments.

The fluorine mass balance shows total fluorine recovery >75% for experiments conducted at 475 and 500° C. (FIG. 7); however, the total fluorine mass balance is not well-closed for experiments conducted at 425 and 450° C. This can be attributed to potential formation of lower 1\4W reaction products in the gaseous phase and/or liquid phase. Gaseous products are not analyzed due to the difficulty of performing non-targeted analysis of fluorocarbons in the gaseous phase at low concentrations via GC-MS. However, the poor closure of the fluorine mass balance is a strong indicator that lower MW fluorinated species could be formed and off-gassed at the lower temperature reaction conditions.

Effects of Reaction Temperature & Residence Time

Increasing the reaction temperature results in an increased extent of destruction for PFOS, PFHpS, and increased fluoride production. Increasing residence time also increases the extent of PFOS destruction and fluoride production. However, the maximum PFOS destruction efficiency of 70.0% achieved after 60 min. of reaction at 500° C. is not sufficient to lower the resulting PFOS concentration below the EPA health advisory level of 70 ng/L. Additionally, the longer residence time of 60 min. does not produce a significant increase in PFOS destruction for experiments conducted at 500° C. One possible explanation may be partitioning of oxidant and PFOS within the reactor. As H₂O₂ decomposes to O₂ at higher temperatures, O₂ may partition toward the bottom of the reactor. The density of O₂ is 0.1158 g/mL while the density of water is 0.0897 g/mL (both at 500° C. and 25 MP a), thus density-driven stratification could drive O₂ toward the bottom of the batch reactor and limit interaction of O₂ with PFOS molecules. Additionally, PFOS likely partition to the reactor walls within the hydrothermal environment, due to the hydrophobicity of the PFOS molecule coupled with the polar solvent behavior of supercritical water, consistent with the known phenomenon of PFAS readily sorbing to various soils and minerals and partitioning to phase interfaces. Regardless of the physical explanation, the destruction efficiencies of PFOS and PFHpS, shown in FIGS. 4 and 5, appear asymptotic at long residence times, indicating that temperature, not residence time, is the key driver of parent compound destruction in the batch configuration. FIG. 6 shows increase in fluoride production with increasing residence time, suggesting greater conversion of unidentified reaction intermediates at longer residence times.

Reaction Mechanism

It appears that C—S bond cleavage is the initial reaction step for the destruction of perfluoroalkane sulfonates under SCWO conditions. SCWO is known to favor free-radical mechanisms driven by hydroxyl (OH) and hydroperoxyl (HO₂) radicals, formed here through H₂O₂ decomposition. Carter and Farrell (Carter, K. E.; Farrell, J. Oxidative destruction of perfluorooctane sulfonate using boron-doped diamond film electrodes. Environ. Sci. Tech. 2008, 42, 6111-6115) previously investigated the energy barriers to hydroxyl radical attack on the PFOS molecule at the (i) —SO₃ site, (ii) a —F site, and (iii) C—C bond site via density functional theory (DFT), in the context of electrochemical oxidation. The —SO₃ site is the most energetically accessible site for reaction, with an activation barrier of 122 kJ/mol. C—C bond cleavage is the next most energetically available reaction, with an activation barrier of 169 kJ/mol, and C—F bond cleavage is the least available, with an activation barrier of 241 kJ/mol.

These activation energy barriers are consistent with the activation energy values of other recalcitrant, heteroatomic chemical species which can be destroyed by SCWO processing. Bianchetta et al. (Bianchetta, S.; Li, L.; Gloyna, E. F.; Supercritical water oxidation of methylphosphonic acid. Ind. Eng. Chem. Res. 38, (1999) 2902-2910) studied the continuous SCWO kinetics of methylphosphonic acid (MPA), a surrogate species for chemical warfare agents, and measured an activation energy of 186±36 kJ/mol for MPA conversion. Experiments conducted at 400° C. resulted in <5% conversion, while experiments conducted at 550° C. resulted in >99.9% conversion. It follows that SCWO processing of PFOS, with similar activation energy barriers for breaking C—C and C—F bonds via oxidative radical attack, will require similar temperatures to achieve high conversion levels.

Should C—F bond cleavage occur as an initial reaction step, some production of fluorotelomer sulfonates or fluorotelomer alkanoic acids may be witnessed. However, none are detected during targeted LC-QToF-MS screening. No perfluoroalkane sulfonates, aside from PFOS, PFHpS, and PFHxS, (all in decreasing levels), or perfluoroalkanoic acids are detected as reaction intermediates. Alongside the observation of significant PFOS conversion with correspondingly high fluoride production, it appears that the initial C—S cleavage step is also the rate-limiting step for overall conversion. This is well-supported by the ˜100% fluoride mass balance at 475 and 500° C.

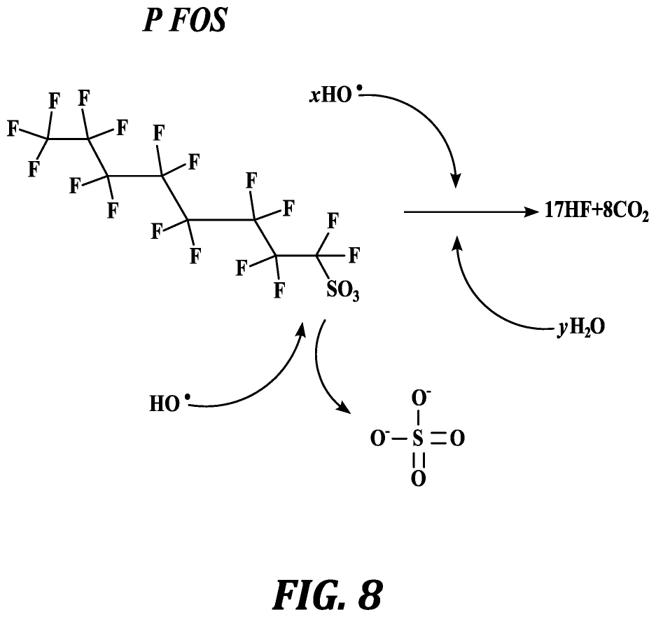

Following cleavage of the sulfonate group, the C—C bonds of the perfluorooctyl radical are susceptible to hydrolysis and/or radical attack. Wu et al. previously demonstrated hydrolysis of PFOA within 30 minutes in hot-compressed water at 200° C., suggesting that hydrolysis of the intermediate PFAS formed after C—S bond cleavage is driven by reaction with water molecules, which are abundantly present in SCWO. FIG. 8 shows a global reaction mechanism, where C—S bond cleavage is followed by hydrolysis and/or oxidative radical attack, ultimately producing final products of HF and CO₂.

### Example 2: Destruction and Defluorination of PFAS in a Continuous SCWO Reactor

Reagents

Heptadecafluorooctanesulfonic acid solution (˜40 wt %, synonym: PFOS), perfluorooctanoic acid (95 wt %), perfluoroheptanoic acid (99 wt %), and heptafluorobutyric acid (98 wt %, synonym: PFBA) from Sigma Aldrich are used for reagent preparation. Deionized (DI) water (p=18.2 M-Ω) is used for preparation of all liquid reagents. The initial reagent contains PFOS, PFOA, PFHpA, and PFBA, at a concentration of ˜1 g/L each. A compressed air cylinder (Breathing Grade) from Praxair is used as the oxidant source in all experiments. Reagent grade ethanol (99.8%, Fisher Scientific) is diluted with DI water and used as a pilot fuel for all experiments.

Experimental Apparatus and Procedures

Continuous SCWO reactors can achieve processing temperatures of 500 to 650° C. and residence times of 5 to 60 s, with characteristically fast reaction kinetics due to the high reaction temperatures, high density of the reaction environment, and enhanced mixing of reacting species.

The SCWO reactor used for this study is a continuous, downflow reactor which operates using a pilot fuel as an internal heat source. The SCWO reactor consists of four influent lines (i) preheated ethanol-water mixture, (ii) preheated compressed air-water mixture, (iii) feedstock, and (iv) quench water. HPLC pumps continuously introduce the influents into the reactor, with individually selectable mass flow rates. Only water is run through the system during preheating; once the desired temperatures for ignition are reached, the ethanol and compressed air are introduced by switching three-way solenoid valves on the pump inlet lines. Reactor influent lines are preheated by resistive cartridge heaters before injection into the reactor through a custom, co-flow nozzle.

The reaction section is a titanium-lined vessel, with an internal volume of ˜1120 mL. The titanium liner has an inner diameter (ID) of 24.25 mm and sits within a stainless steel 316 (SS316) outer tube with an ID of 25.4 mm and an outer diameter (OD) of 38.1 mm.

After passing through the reactor section, the effluent is quenched through a heat exchanger and subsequently throttled across a back-pressure regulator (BPR), which is used to control the internal pressure. Liquid and gaseous products are collected on the effluent line after product quenching.

Steady-state operating temperatures are varied from 510 to 640° C., and with residence times held near-constant around 25 s, and experimental pressure maintained above 25 MPa. Table 1 shows the full range of experimental conditions.

Product Analysis

Liquid samples are analyzed via fluoride ion-selective electrode (ISE) for the resulting concentration of F⁻ ions, and via targeted high-resolution LC-MS/MS to quantify the presence and concentration of 28 potential PFAS compounds in the liquid product. A full list of PFAS analytes (MI List) is available in Table 5. Between fuel, water, and oxidant injection, the overall feedstock is diluted by a factor of 10-20; Destruction and defluorination efficiencies are corrected accordingly. Measured fluoride yields and defluorination efficiencies are shown in Table 1.

TABLE 1
Continuous SCWO experiment parameters
and defluorination efficiencies

| Temperature | Residence Time | Normalized F- | Defluorination |
|---|---|---|---|
| (° C.) | (s) | Yield (mg/L) | Efficiency (%) |
| 510 | ~27 | 611.7 | 25.0 |
| 565 | ~26 | 1193.5 | 48.7 |
| 610 | ~25 | 2124.9 | 86.4 |
| 640 | ~24 | 2467.3 | 99.99 |

Based on the results shown in Table 1, SCWO temperatures >600° C. and residence times >20 s are ideal for near-complete conversion of PFAS to fluoride. Longer residence times, higher oxidant loading, and/or higher temperatures can be used to drive more complete conversion.

### Example 3: Destruction and Defluorination of PFAS in a Batch Halt Reactor

Reagents

Heptadecafluorooctanesulfonic acid solution (˜40 wt %, synonym: PFOS), perfluorooctanoic acid (95 wt %), perfluoroheptanoic acid (99 wt %), and heptafluorobutyric acid (98 wt %, synonym: PFBA) from Sigma Aldrich are used for reagent preparation. Deionized (DI) water (p=18.2 M-Ω) is used for preparation of all liquid reagents. The initial reagent contains PFOS (C₈HF₁₇SO₃), PFOA (C₈HF₁₅O₂), PFHpA (C₇HF₁₃O₂), and PFBA (C₄HF₇O₂), at concentrations of ˜1 g/L each. This translates to an overall initial F loading in the reagent of 2.634 g-F/L. Full PFAS destruction and defluorination should yield a measured F⁻ concentration near to this value.

Experimental Apparatus and Procedures

A 50 mL stainless steel 316 (SS316) batch reactor is used for initial experiments, designed to operate at temperatures up to 500° C. and pressures up to 35 MPa. Details of the reactor apparatus are shown in FIG. 3. The reactor is equipped with an internal 3.175 mm diameter Type-K thermocouple and a pressure gauge for ensuring isothermal and isobaric reaction conditions. Pressurized N₂ is used to purge air from the system, and to provide an inert gas cap at an initial pressure required to achieve the desired experimental pressure of 25 MPa after heating to supercritical conditions. Isothermal reaction conditions are achieved by inserting the sealed reactor vessel into an Applied Test Systems (Butler, Pa.) Series 3110 furnace. During each experiment, the reactor is placed into the furnace and brought to the desired internal temperature, defined as the “zero time”. After reaching the desired residence time the reactor is removed from the furnace and cooled to room temperature. The gaseous products are vented, the reactor is opened, and liquid products are collected in HDPE sample containers. The system is rinsed several times with DI water between experiments.

During batch experiments, the reactor is placed into the furnace and brought to the desired experimental temperature, defined as the experimental “zero time”. After reaction for the desired residence time the reactor is removed from the furnace and fan-cooled to room temperature. The gaseous products are vented, the system is opened, and liquid products are collected in HDPE sample containers. The system is rinsed with DI water between experiments.

In these experiments, 15 to 35 mL of reagent are loaded into the reactor. NaOH (>97 wt %, Fisher Scientific) is used for reagent preparation in some cases (see Table 2). HCl (36.5-38.0 wt %, Millipore Sigma) is used for pH buffering post-treatment in experiments where NaOH is used. The reaction temperature is 350° C., with a reaction pressure of −25 MPa generated autogenically through expansion of the liquid. The reaction time is 60 min for all experiments. Total ionic strength adjustment buffer (TISAB) from Fisher Scientific is mixed with the reaction product prior to analysis with fluoride selective electrode (FSE). TISAB assists with pH buffering, and also ensures that F⁻ ions are not complexing during analysis.

In some experiments, a sapphire or quartz liner was used (see Table 2). The final fluoride concentration is calculate based on the equation

C₁V₁=C₂V₂

where the concentration of fluoride in the effluent (C₁) is related to the measured fluoride concentration in the buffered solution (C₂) based on the volume change (dilution) between the two. Defluorination efficiency is calculated by dividing the fluoride concentration by 2634 mg/L, which is the known starting concentration of fluorine in the mixture.

Results

Table 2 shows that reaction at 350° C. for 60 min without alkaline amendment does not results in significant defluorination. Addition of 5 M-NaOH results in measured defluorination of 84.2%.

A significant goal of these experiments was to assess the stability of various liner/reactor materials. A single-crystalline sapphire liner was added to test whether a stable ceramic liner material could be used to mitigate corrosion of the reactor surface. Several experiments conducted with sapphire did not produce notable fluoride yields, leading to the premise that the SS316 reactor surface may be catalytically driving the reaction. However, addition of a SS316 tube into the sapphire liner still did not produce measurable fluoride yields. Ultimately it was discovered that the sapphire was reacting with the alkali amendment and fluoride to produce an insoluble fluoride complex. For this reason, the use of a sapphire liner was abandoned for future experiments.

A quartz liner was also tested. The quartz was found to be unstable under the highly alkaline conditions and suffered notable damage during the experiment. However, the resulting fluoride yield was ˜100%, indicating that a non-reactive liner material could be used to mitigate corrosion in the reaction vessel. The use of quartz was also abandoned for future experiments due to its instability under the reaction conditions.

TABLE 2
Results from HALT defluorination experiments with various liner + amendment combinations.

| | | | | | Fluoride | | |
|---|---|---|---|---|---|---|---|
| | | | HCl | | Probe | Fluoride | Measured |
| | | Volume | Added | Effluent:TISAB | Reading | Concentration | Defluorination |
| Liner? | Amendment | (mL) | (mL) | Ratio | (mg/L) | (mg/L) | (%) |
| No | None | 35 | 0 | 25:25 | 444.5 | 889.1 | 33.8 |
| No | 5M-NaOH | 35 | 24 | 25:25 | 658.1 | 2218.7 | 84.2 |
| Sapphire | 5M-KOH | 15 | 5.5 | 20:30 | 0.165 | 0.554 | 0.02 |
| Sapphire | 5M-KOH + | 15 | 5.2 | 20:30 | 0.686 | 2.403 | 0.09 |
| | SS316 Tube | | | | | | |
| Quartz | 5M-NaOH | 15 | 1.2 | 15:35 | 638.7 | 2725.3 | 103.5 |

Based on the results presented here, the ideal conditions for PFAS conversion to fluoride in subcritical water involve reaction at (i) T˜350° C., (ii) P˜25 MPa, (iii) [OH⁻]˜5 M, (iv) reaction time ˜60 min. pH buffering and TISAB addition is needed for analysis via FSE, while pH buffering alone is sufficient for analysis via ion chromatography (IC).

Reaction conditions can be altered and still yield acceptable results. Temperatures as low as 250° C. will still yield defluorination, but longer residence times and/or higher [OH⁻] loading is needed to achieve ˜100% defluorination. Temperatures higher than 350° C. may also be used, but care must be taken to manage the expansion of water at these temperatures, as pressure must be kept within a safe operational range.

Pressure can be any value high enough to keep the reactants liquid (or liquid-like) at the reaction temperature. [OH⁻] loading can also be reduced, but longer reaction times and high temperatures would be needed for ˜100% defluorination. Alternately, [OH⁻] loading could be increased to the solubility limit of the hydroxide in liquid water, which would speed reactions. Longer reaction times may also be used to ensure that near-complete defluorination is achieved.

### Example 4: Destruction and Defluorination of PFAS in Landfill Leachate

The efficacy of the HALT process toward the destruction of PFAS in a landfill leachate matrix was studied. Landfill leachate is a complex liquid matrix, containing high levels of total suspended solids, (TSS), total dissolved solids (TDS), and chemical oxygen demand (COD), which can cause interference with many PFAS destruction processes. Leveraging both a batch HALT reactor and a continuous HALT reactor, the rates of PFAS destruction in the two system configurations are compared.

Materials & Methods

Leachate from an active landfill in Mexico is provided from an industrial partner, with characteristics shown in Table 3. A 100 μg/mL analytical standard of perfluorooctanesulfonic acid (PFOS) in methanol (Supelco) is used to dope leachate to a target initial PFOS concentration of 100 μg/L. The resulting initial PFAS concentrations in the leachate is shown in Table 4, as measured by commercial LC-MS/MS; several other PFASs are detected, likely due to impurities in the PFAS used for doping. All other PFASs screened for in EPA Method 537.1 (Table 5) are below detection limits. NaOH (>97 wt %, Fisher Scientific) is used for reagent preparation. HCl (36.5-38.0 wt %, Millipore Sigma) is used for pH buffering post-treatment.

TABLE 3
Influent characteristics of untreated landfill leachate.

| | |
|---|---|
| Total Suspended Solids (mg/L)^{b} | 110 |
| Total Dissolved Solids (mg/L)^{b} | 14000 |
| Total P (mg/L)^{b} | 31 |
| Total N (mg/L)^{a} | 1143 |
| Biological Oxygen Demand (mg/L)^{b} | 129 |
| Chemical Oxygen Demand (mg/L)^{b} | 6281 |
| Total Organic Carbon^{a} | 4710 |
| Alkalinity, Total (mg-CaCO₃/L)^{b} | 17000 |

^{a}Measured,
^{b}information supplied by project partner.

TABLE 4
PFAS levels in untreated (doped) landfill leachate

| PFAS Compound | Concentration (μg/L) |
|---|---|
| Perfluorohexanoic acid (PFHxA) | 1.67 |
| Perfluoroheptanoic acid (PFHpA) | 0.557 |
| Perfluorooctanoic acid (PFOA) | 1.16 |
| Perfluorobutanesulfonic acid (PFBS) | 4.63 |
| Perfluorohexanesulfonic acid (PFHxS) | 10.1 |
| Perfluorooctanesulfonic acid (PFOS) | 81.9 |
| Total PFAS | 100.017 |

Batch Reactor

A 50 mL stainless steel 316 (SS316) batch reactor is used for initial experiments, designed to operate at temperatures up to 500° C. and pressures up to 35 MPa. Details of the reactor apparatus are shown in FIG. 3 and already described in Example 3.

During each experiment, the reactor is placed into the furnace and brought to the desired internal temperature, defined as the “zero time”. After reaching the desired residence time the reactor is removed from the furnace and cooled to room temperature. The gaseous products are vented, the reactor is opened, and liquid products are collected in HDPE sample containers. The system is rinsed several times with DI water between experiments.

During batch experiments, the reactor is placed into the furnace and brought to the desired experimental temperature, defined as the experimental “zero time”. After reaction for the desired residence time the reactor is removed from the furnace and fan-cooled to room temperature. The gaseous products are vented, the system is opened, and liquid products are collected in HDPE sample containers. The system is rinsed with DI water between experiments.

Continuous Reactor

A continuous, tubular reactor is used to evaluate the effect of system configuration on observed PFAS destruction rates. A process flow diagram (PFD) of the continuous system is shown in FIG. 9. A positive displacement pump introduces a premixed feedstock of PFAS-doped landfill leachate with 5 M-NaOH into a coiled, tubular reactor section with an internal heated volume of 55.3 mL. Radiant heaters maintain isothermal conditions of 350° C., as measured by two Type-K thermocouples in contact with the flow at intermediate locations. The residence time is calculated assuming a plug flow regime (neglecting laminar flow profile effects), and assuming the reacting flow density is equal to the density of water at 350° C. Rapid quenching is accomplished with a heat exchanger, before liquid products are collected in HDPE sample containers.

After reaction in both reactor configurations, HCl is added to buffer the solution pH to a value between 5 and 7 (ideally between 5 and 5.5), as measured by pH strips. The dilution effect of HCl addition is factored into correcting the measured effluent characteristics.

Experimental Conditions

The overall loading of NaOH is maintained at 5 M. The batch reactor is operated at 350° C., with a residence time of 120 min. The internal pressure reaches >25 MPa autogenically, through liquid expansion. The continuous reactor is operated at a constant internal temperature of 350° C., and residence times of 15, 30, 45, and 60 min. Internal pressure is held at 25 MPa.

Product Analysis

Untreated and batch-reactor-treated landfill leachate is analyzed for 18 PFAS analytes via LC-MS/MS using EPA Method 537.1 (SGS; Orlando, Fla.). Samples treated in the continuous reactor are analyzed for 26 PFAS analytes via LC-MS/MS, using the Michigan list (SGS; Orlando, Fla.). Table 5 shows the analytes included in analysis. Untreated and treated landfill leachate is analyzed for TOC and TN with a Shimadzu TOC-VCSH instrument.

TABLE 5
PFAS analytes in EPA Method 537.1 and Expanded MI List

| | | | | |
|---|---|---|---|---|
| | | Neutral | | |
| | | Molecular | EPA 537.1 | MI |
| Chemical Name | Acronym | Formula | List | List |

Perfluoroalkanoic acids

| | | | | |
|---|---|---|---|---|
| Perfluoro-n-butanoic acid | PFBA | C₄HO₂F₇ | | X |
| Perfluoro-n-pentanoic acid | PFPeA | C₅HO₂F₉ | | X |
| Perfluoro-n-hexanoic acid | PFHxA | C₆HO₂F₁₁ | X | X |
| Perfluoro-n-heptanoic acid | PFHpA | C₇HO₂F₁₃ | X | X |
| Perfluoro-n-octanoic acid | PFOA | C₈HO₂F₁₅ | X | X |
| Perfluoro-n-nonanoic acid | PFNA | C₉HO₂F₁₇ | X | X |
| Perfluoro-n-decanoic acid | PFDA | C₁₀HO₂F₁₉ | X | X |
| Perfluoro-n-undecanoic acid | PFUnA | C₁₁HO₂F₂₁ | X | X |
| Perfluoro-n-dodecanoic acid | PFDoA | C₁₂HO₂F₂₃ | X | X |
| Perfluoro-n-tridecanoic acid | PFTrDA | C₁₃HO₂F₂₅ | X | X |
| Perfluoro-n-tetradecanoic acid | PFTeDA | C₁₄HO₂F₂₇ | X | X |

Perfluoroalkane Sulfonates

| | | | | |
|---|---|---|---|---|
| Perfluorobutane sulfonate | PFBS | C₄HO₃SF₉ | X | X |
| Perfluoropentane sulfonate | PFPeS | C₅HO₃SF₁₁ | | X |
| Perfluorohexane sulfonate | PFHxS | C₆HO₃SF₁₃ | X | X |
| Perfluoroheptane sulfonate | PFHpS | C₇HO₃SF₁₅ | | X |
| Perfluorooctane sulfonate | PFOS | C₈HO₃SF₁₇ | X | X |
| Perfluorononane sulfonate | PFNS | C₉HO₃SF₁₉ | | X |
| Perfluorodecane sulfonate | PFDS | C₁₀HO₃SF₂₁ | | X |

Perfluoroalkane sulfonamides

| | | | |
|---|---|---|---|
| Perfluorooctane sulfonamide | FOSA | C₈H₂O₂SNF₁₇ | X |

Perfluoroalkane sulfonamido acetic acids

| | | | | |
|---|---|---|---|---|
| N-methylperfluorooctane | MeFOSAA | C₁₁H₆O₄SNF₁₇ | X | X |
| sulfonamido acetic acid | | | | |
| N-ethylperfluorooctane | EtFOSAA | C₁₂H₈O₄SNF₁₇ | X | X |
| sulfonamido acetic acid | | | | |

Fluorotelomer Sulfonates

| | | | |
|---|---|---|---|
| 4:2 fluorotelomer sulfonate | 4:2 FTS | C₆H₅O₃SF₉ | X |
| 6:2 fluorotelomer sulfonate | 6:2 FTS | C₈H₅F₁₃SO₃ | X |
| 8:2 fluorotelomer sulfonate | 8:2 FTS | C₁₀H₅O₃SF₁₇ | X |

Perfluoroether Carboxylic/Sulfonic Acids (PFECA/PFESA)

| | | | |
|---|---|---|---|
| 4,8-dioxa-3H-perfluorononanoic | ADONA | C₇H₂O₄F₁₂ | X |
| acid | | | |
| Tetrafluoro-2- | HFPO-DA | C₆HO₃F₁₁ | X |
| (heptafluoropropoxy)-propanoic acid | | | |
| (GenX) | | | |
| 9-chlorohexadecafluoro-3- | 9Cl-PF3ONS | C₈HO₄SClF₁₆ | X |
| oxanone-1-sulfonic acid (F-53B Major) | | | |
| 11-chloroeicosafluoro-3 | 11Cl-PF3OUdS | C₁₀HO₄SClF₂₀ | X |
| oxaundecane-1-sulfonic acid (F-53B Minor) | | | |

Results & Discussion

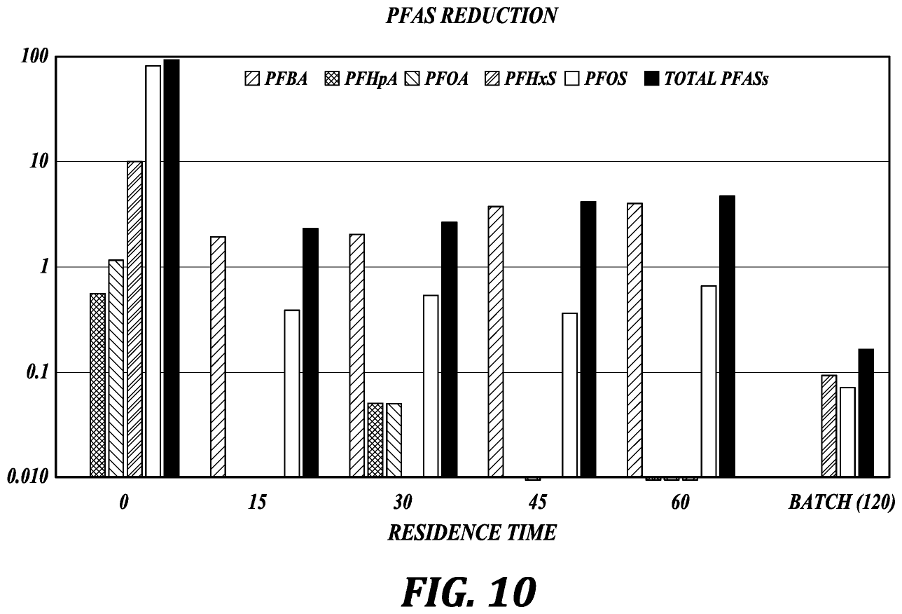

Measured levels of PFAS in reactor effluent shows that total PFAS levels are reduced by >95% during continuous HALT processing at all tested residence times. FIG. 10 is a graph showing PFAS reduction using a batch and continuous reactor at various residence times. FIG. 10 is plotted on a logarithmic scale, to show orders-of-magnitude destruction achieved for all experiments. For all continuous HALT experiments, PFOS levels are reduced by >99%, while the batch HALT experiment successfully reduced PFOS levels by >99.9%. PFBA was observed as a more recalcitrant species during continuous HALT processing.

### CONCLUSIONS

These results clearly demonstrate several positive conclusions related to using the HALT process to treat landfill leachate. Namely, (i) HALT processing can destroy >99% of PFOS in batch and continuous reactor configurations, and (ii) PFAS destruction kinetics in a continuous HALT reactor are faster than in a batch HALT reactor.

While illustrative embodiments have been illustrated and described, it will be appreciated that various changes can be made therein without departing from the spirit and scope of the invention.

1. An apparatus for determining a concentration of one or more halogen-containing ions in a sample, comprising:
a reactor having a first inlet connected to the sample supply and an outlet, the reactor configured for contacting the sample in a volume of water under supercritical conditions to form a product;
a collection zone having an inlet connected to the outlet of the reaction zone, and an outlet, the collection zone configured for reducing the temperature of the product; and
an analyzer having an inlet connected to the outlet of the collection zone, the analyzer configured to determine the concentration of the one or more halogen-containing ions in the sample.

2. The apparatus of claim 1, wherein the sample is contacted with an oxidant.

3. The apparatus of claim 1, wherein the reactor comprises one or more of second inlets, wherein the one or more of second inlets are connected to an oxidant supply, a water supply, or both.

4. (canceled)

5. The apparatus of claim 1, wherein the collection zone further comprises a cooling zone configured to reduce the temperature of the product.

6. (canceled)

7. The apparatus of claim 1, wherein the collection zone further comprises a pressure regulator configured to reduce the pressure in the collection zone.

8-10. (canceled)

11. The apparatus of claim 1, wherein the collection zone further comprises a second inlet, for introducing a solution serving as a pH buffer or a total ionic strength adjustment buffer (TISAB).

12. The apparatus of claim 1, wherein the analyzer comprises a detector for halogen ions including one or more of F⁻, Cl⁻, Br⁻, I⁻, or At⁻.

13-14. (canceled)

15. The apparatus of claim 1, wherein the reactor is maintained at a temperature in a range of 500° C. to 750° C. and at a pressure sufficient to maintain a supercritical phase of water.

16-18. (canceled)

19. A method for determining a concentration of one or more halogen-containing ions in a sample, comprising:
contacting the sample with an oxidant in a volume of water under supercritical conditions to form a product in a reactor;
in a collection zone, reducing the temperature of the product; and
providing the cooled product to an analyzer to determine the concentration of the one or more halogen-containing ions in the sample.

20. The method of claim 19, wherein contacting the sample in the reactor is at a temperature in a range of 500° C. to 750° C. and at a pressure sufficient to maintain a supercritical phase of water.

21-22. (canceled)

23. The method of claim 19, wherein the sample is a solid sample (e.g. at least one of sewage, soil, compost, tissue landfill leachate, groundwater, drinking water, or blood.

24. (canceled)

25. The method of claim 19, wherein the analyzer is an ion chromatograph or an ion selective electrode.

26. The method of claim 19, further comprising determining the concentration of F⁻ ions.

27-31. (canceled)

32. A method for determining a concentration of fluoride ions in a sample, comprising:
contacting the sample with an alkaline amendment in a volume of water under sub-critical liquid water conditions to form a product in a reactor;
cooling the product; and
providing the cooled product to an analyzer to determine the concentration of the fluoride ions in the sample.

33. The method of claim 32, wherein the contacting the sample is at a temperature less than 374° C. and at a pressure sufficiently high to maintain a liquid phase of water.

34. The method of claim 32, wherein the alkaline amendment is selected from NaOH, KOH, LiOH, NH₄OH, or a combination.

35. The method of claim 32, wherein the sample is at least one of sewage, soil, compost, tissue landfill leachate, groundwater, drinking water, or blood.

36. (canceled)

37. The method of claim 32, wherein the analyzer is an ion chromatograph or an ion selective electrode.

38. The method of claim 32, wherein the analyzer is coupled to the reactor with a conduit and the method comprises transferring the product from the reactor to the analyzer after the cooling step.

39. (canceled)

40. The method of claim 32, wherein the sample includes per- and/or polyfluoroalkyl substances (PFAS).
